(19) United States
(12) Patent Application Publication
(10) Pub. No.: US 2010/0077431 A1
(43) Pub. Date: Mar. 25, 2010

(54) User Interface having Zoom Functionality

(75) Inventors: Nadav M. Neufeld, Sunnyvale, CA (US); Gionata Mettifogo, Menlo Park, CA (US); Charles J. Migos, San Francisco, CA (US); Afshan A. Kleinhanzl, San Francisco, CA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 12/237,715

(22) Filed: Sep. 25, 2008

(51) Int. Cl. H04N 5/445; H04N 5/262; G06F 3/041; H04N 5/45; G06F 3/00

(52) U.S. Cl. 725/39; 348/581; 345/173; 715/719; 348/E05.055

(57) ABSTRACT

A user interface having zoom functionality is described. In an implementation, a user interface is displayed having representations of a plurality of content. Each of the representations is formed using a respective picture-in-picture stream of respective content. When an input is received to select a particular one of the representations, the respective content is displayed by zooming in from the picture-in-picture stream of the respective content to a respective video stream of the respective content.

### BACKGROUND

Users have access to an ever increasing amount and variety of content. For example, users may access the Internet using desktop computers, mobile phones, and so on. However, as the amount and variety of content continues to increase, the traditional techniques that were used to access the content may become inefficient and therefore frustrating to the users.

For example, a user may have access to hundreds of television channels that are broadcast by a network operator, such as via cable, satellite, a digital subscriber line (DSL), and so on. Traditionally, users “surfed” through the channels via channel up or channel down buttons to determine what was currently being broadcast on each of the channels. As the number of channels grew, electronic program guides were developed such that the users could determine “what was on” a particular channel without tuning to that channel. However, as the number of channels continued to grow, the techniques employed by traditional EPGS to manually scroll through this information also became inefficient and frustrating to the users.

### SUMMARY

A user interface having zoom functionality is described. In an implementation, a user interface is displayed having representations of a plurality of content. Each of the representations is formed using a respective picture-in-picture stream of respective content. When an input is received to select a particular one of the representations, the respective content is displayed by zooming in from the picture-in-picture stream of the respective content to a respective video stream of the respective content.

In an implementation, a user interface is output having a still representation of each of a plurality of content that is available via a respective one of a plurality of channels. When an input is received to select a portion of the user interface, one or more of the representations that are included in the portion of the user interface are enlarged and configured to be displayed in the user interface in motion. When an input is received to select an enlarged one of the representations, the selected representation is further enlarged in the user interface to output respective content.

In an implementation, a client includes a housing having a form factor of a table, a surface disposed on a table top of the housing, and one or more modules. The one or more modules are disposed within the housing to display a user interface on the surface having representations of a plurality of content and when an input is received to select a particular one of the representations, respective content is displayed by zooming in from the representations of the plurality of content to the respective content.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different instances in the description and the figures may indicate similar or identical items.

FIG. 1 is an illustration of an environment in an example implementation that is operable to perform object detection and user setting techniques.

FIG. 2 is an illustration of a system in an example implementation showing a client of FIG. 1 in greater detail.

FIG. 3 is an illustration of a system in an example implementation in which the client of FIGS. 1 and 2 outputs a user interface that is configured to interact with content received from a content provider.

FIG. 4 is an illustration of a system in an example implementation in which the user interface of FIG. 3 is zoomed in such that representations of content in a selected genre are enlarged.

FIG. 5 is an illustration of a system in an example implementation in which a user interface is used to output content selected through interaction with the user interface of FIG. 4.

FIG. 6 is a flow diagram depicting a procedure in an example implementation in which a user interface having representations of content is navigated through using one or more zoom techniques.

FIG. 7 is a flow diagram depicting a procedure in an example implementation in which representations of content in the user interface are enlarged from a still image to a picture-in-picture screen to a video stream.

### DETAILED DESCRIPTION

Overview

As the amount of content that is available to users continues to increase, traditional techniques that were developed to navigate through and select content continue to become increasingly inefficient. For example, users traditionally navigated through television programs using “channel up” and “channel down” buttons on a remote control. As the amount of channels increased, electronic program guides were developed such that users could “see what was on” particular channels without actually navigating to those channels. However, electronic program guides were also typically configured to use a scrolling technique that involved the channel up and channel down buttons to navigate through the information that described what was on each channel. Consequently, it could take a significant amount of time for a user to navigate through the hundreds of channels that may be available to the user, thereby resulting in user frustration and annoyance when interacting with the traditional electronic program guide.

A user interface having zoom functionality is described. In an implementation, a user interface is displayed having representations of each of a plurality of content. For example, each representation may represent what is on a particular channel, such as through use of a still image. The user may then “zoom in” a particular portion of the user interface to obtain additional information about the content and that portion. For instance, the user interface may be arranged by genre and therefore a user that is interested in sports may select a portion of the user interface having representations of content that relate to sports. This portion may be “zoomed in” such that the user may view a picture-in-picture stream of content that relates to sports, thereby taking advantage of an increased amount of display area that may be consumed by respective representations.

In this level, the user may view the picture-in-picture streams and zoom in again to display particular content of interest. In response to this zoom, a video stream of the actual content may then be displayed in the user interface, which may include an output of audio for consumption by the user. Similar techniques may also be used by the user to “zoom out” back through levels of representations of content in the user interface, e.g., from the video streams of the actual content to picture-in-picture streams to still images. In this way, the user interface may provide a plurality of levels through which the user may zoom in and zoom out to obtain additional information about content. Additionally, the user may pan through the representations in each of the levels to view additional representations that are not currently displayed for that level, e.g., “off screen”. Thus, a user may move through different levels of detail and different representations at those levels to navigate through content. A variety of other examples are also contemplated, further discussion of which may be found in relation to the following sections.

In the following discussion, an example environment is first described that is operable to perform one or more techniques that pertain to a user interface having zoom functionality. Example procedures are then described which may be implemented using the example environment as well as other environments. Accordingly, implementation of the procedures is not limited to the example environment and the example environment is not limited to implementation of the example procedures. For example, although television programming and an electronic program guide are described, a variety of different content and user interfaces may leverage the techniques described herein, such as desktop user interfaces, music interfaces, image (e.g., photo interfaces), and so on.

Example Environment

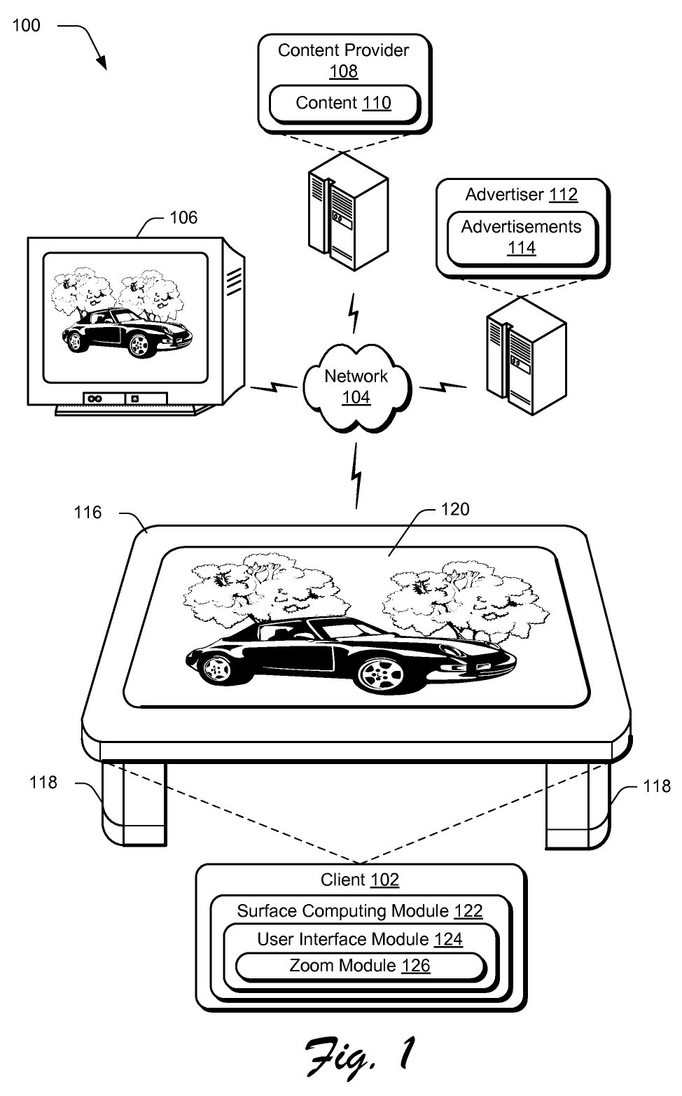

FIG. 1 is an illustration of an environment 100 in an example implementation that is operable to employ techniques involving a user interface having zoom functionality. The illustrated environment 100 includes a client 102 that is communicatively coupled via a network 104 to another client 106 configured as a television, a content provider 108 having content 110, and an advertiser 112 having one or more advertisements 114.

The client 102 may be configured in a variety of ways. For example, the client 102 may be configured as a computer that is capable of communicating over the network 104, such as a desktop computer, a mobile station, an entertainment appliance, a set-top box communicatively coupled to a display device, a wireless phone, a game console, and so forth. Thus, the client 102 may range from full resource devices with substantial memory and processor resources (e.g., personal computers, game consoles) to a low-resource device with limited memory and/or processing resources (e.g., traditional set-top boxes, hand-held game consoles). The clients 102 may also relate to a person and/or entity that operate the clients. In other words, clients 102 may describe logical clients that include software that is executed on one or more computing devices.

Although the network 104 is illustrated as the Internet, the network may assume a wide variety of configurations. For example, the network 104 may include a wide area network (WAN), a local area network (LAN), a wireless network, a public telephone network, an intranet, and so on. Further, although a single network 104 is shown, the network 104 may be configured to include multiple networks. For instance, the client 102 and the other client 106 (the television) may be communicatively coupled via a local network connection, one to another. Additionally, the client 102 may be communicatively coupled to the content provider 108 over the Internet. Likewise, the advertiser 112 may be communicatively coupled to the content provider 108 via the Internet. A wide variety of other instances are also contemplated.

In the illustrated environment 100, the client 102 is illustrated as having a form factor of a table. The table form factor includes a housing 116 having a plurality of legs 118. The housing 116 also includes a table top having a surface 120 that is configured to display one or more images, such as the car as illustrated in FIG. 1.

The client 102 is further illustrated as including a surface computing module 122. The surface computing module 122 is representative of functionality of the client 102 to provide computing-related functionality that leverages the surface 120 and detection of objects via the surface. For example, the surface computing module 122 may be configured to output a display of a user interface on the surface 120 using a user interface module 124. The surface-computing module 122 may also be configured to detect interaction with the surface 120, and consequently the user interface output on the surface 120. Accordingly, a user may then interact with the user interface via the surface 120 in a variety of ways, such as to select files, initiate execution of a program, and so on.

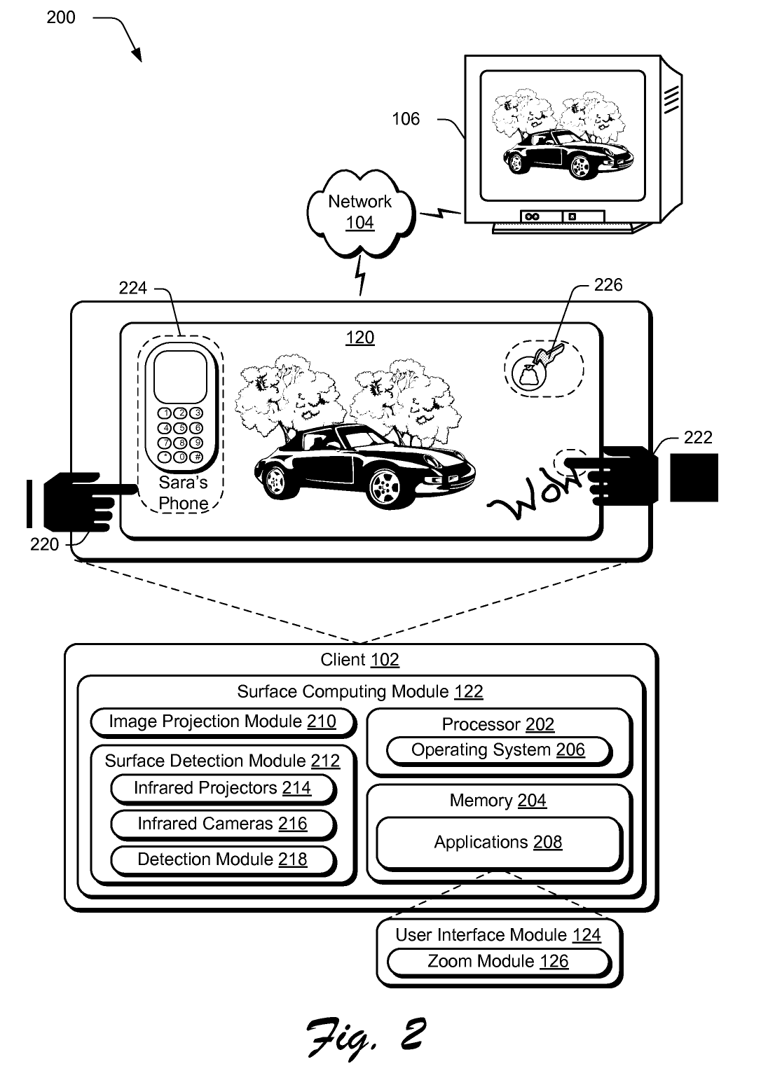

For example, the user may use one or more fingers as a cursor control device, as a paintbrush, to manipulate the user interface (e.g., to resize and move images), to transfer files (e.g., between the client 102 and another client), to obtain content 110 via the network 104 by Internet browsing, to interact with another client 106 (e.g., the television) that is local to the client 102 (e.g., to select content to be output by the television), and so on. Thus, the surface computing module 122 of the client 102 may leverage the surface 120 in a variety of different ways both as an output device and an input device, further discussion of which may be found in relation to FIGS. 2-5.

The client 102 is also illustrated as having a user interface module 124. The user interface module 124 is representative of functionality of the client 102 to configure a user interface for output by the client 102. For example, as previously described the surface computing module 122 may act in conjunction with the surface 120 as an input device. Accordingly, objects placed on or near the surface 120 may be detected by the surface computing module 122 and used as a basis for detecting interaction with a user interface output on the surface 120.

For example, the user interface module 124 may output a user interface configured as an electronic program guide. The electronic program guide may be configured to select which content is output by the client 102 and/or which content is output by another client 106, e.g., the television. A variety of different content is contemplated, including content both local to the client 102 and/or remotely accessed via the network 104, such as content 110 available from a content provider 108 via a broadcast. For instance, the user interface output by the user interface module 124 may be configured to interact with television programs (e.g., movies), music, images (e.g., photos), multimedia data files, and so on.

The user interface module 124 is further illustrated as including a zoom module 126. The zoom module 126 is representative of functionality to “zoom in” and “zoom out” through different levels of detail of representations of content in a user interface of the user interface module 124. For example, the user interface may be output at a “lowest level” of detail to maximize a number of representations of content that may be displayed on the surface 120 at any one time, such as by displaying still images taken from a picture-in-picture stream.

The user interface may also be output at a “highest level” of detail such that a single item of content is displayed in its entirety using available resolution, substantially across an available display area of the surface 120, and so on. One or more intermediate levels may also be provided have different levels of detail between the highest and lowest levels. Therefore, a user may zoom in or zoom out through the different levels of detail to determine characteristics of content that is available for output (now and/or in the future), to locate particular content that may be of interest, and so on. Further discussion of the client 102 and zoom functionality may be found in relation to the following figures.

Generally, any of the functions described herein can be implemented using software, firmware (e.g., fixed logic circuitry), manual processing, or a combination of these implementations. The terms “module,” “functionality,” and “logic” as used herein generally represent software, firmware, or a combination of software and firmware. In the case of a software implementation, the module, functionality, or logic represents program code that performs specified tasks when executed on a processor (e.g., CPU or CPUs). The program code can be stored in one or more computer-readable media, further description of which may be found in relation to FIG. 2. The features of the surface techniques and the zoom functionality techniques that may be employed therein that are described below are platform-independent, meaning that the techniques may be implemented on a variety of commercial computing platforms having a variety of processors and tangible computer-readable media (e.g., memory) that may be used to store the instructions.

FIG. 2 depicts a system 200 in an example implementation showing the client 102 of FIG. 1 in greater detail. The client 102 includes the surface computing module 122 of FIG. 1, which in this instance is illustrated as including a processor 202 and memory 204. Processors are not limited by the materials from which they are formed or the processing mechanisms employed therein.

For example, processor 202 may be comprised of semiconductor(s) and/or transistors (e.g., electronic integrated circuits (ICs)). In such a context, processor-executable instructions may be electronically-executable instructions. Alternatively, the mechanisms of or for processors, and thus of or for a computing device, may include, but are not limited to, quantum computing, optical computing, mechanical computing (e.g., using nanotechnology), and so forth. Additionally, although a single memory 204 is shown, a wide variety of types and combinations of memory may be employed, such as random access memory (RAM), hard disk memory, removable medium memory, and other types of computer-readable media.

The client 102 is illustrated as executing an operating system 206 on the processor 202, which is also storable in memory 204. The operating system 206 is executable to abstract hardware and software functionality of the underlying client 102, such as to one or more applications 208 that are illustrated as stored in memory 204. In this system 200 of FIG. 2, the user interface module 124 having the zoom module 126 is illustrated as being included as part of the applications 208 that are stored in memory 204 of the client 102. For example, at least one of the applications 208 may be configured to output content 110 broadcast over the network 104 by the content provider 108 using a plurality of different channels, such as television programming. It should be readily apparent, however, that the user interface module 124 and the zoom module 126 may be implemented in a variety of ways, such as part of the operating system 206, as a stand-alone module, and so on.

The surface computing module 122 is also illustrated as including an image projection module 210 and a surface detection module 212. The image projection module 210 is representative of functionality of the client 102 to cause an image to be displayed on the surface 120. A variety of different techniques may be employed by the image projection module 210 to display the image, such as through use of a rear-projection system, an LCD or plasma display, and so on.

The surface detection module 212 is representative of functionality of the client 102 to detect one or more objects when placed proximally to the surface 120 of the client 102. The surface detection module 212 may employ a variety of different techniques to perform this detection, such as radio frequency identification (RFID), image recognition, barcode scanning, optical character recognition, and so on.

For example, the surface detection module 212 of FIG. 2 is illustrated as including one or more infrared projectors 214, one or more infrared cameras 216, and a detection module 218. The one or more infrared projectors 214 are configured to project infrared and/or near infrared light on to the surface 120. The one or more infrared cameras 216 may then be configured to capture images of the reflected infrared light from the surface 120 of the client 102.

For instance, objects such as fingers of respective users' hands 220, 222, a user's phone 224, and car keys 226 are visible by the infrared cameras 216 through the surface 120. In the illustrated instance, the infrared cameras 216 are placed on an opposing side of the surface 120 from the users' hands 220, 222, e.g., disposed within a housing of the client 102. The detection module 218 may then analyze the images captured by the infrared cameras 216 to detect objects that are placed on the surface 120 and movement of those objects. An output of this analysis may then be provided to the operating system 206, the applications 208 (and consequently the user interface module 124 and zoom module 126), and so on.

In an implementation, the surface detection module 212 may detect multiple objects at a single point in time. For example, the fingers of the respective users' hands 220, 222 may be detected for interaction with a user interface output by the operating system 206. In this way, the client 102 may supports simultaneous interaction with multiple users, support gestures made with multiple hands of a single user, and so on.

For example, different gestures may be used to enlarge or reduce a portion of a user interface (e.g., an image), rotate an image, move files between devices, select output of a particular item of content, and so on. Although detection using image capture has been described, a variety of other techniques may also be employed by the surface computing module 122 (and more particularly the surface detection module 212) to detect objects placed on or proximate to the surface 120 of the client 102, such as RFID of an object having an RFID tag (e.g., a stylus), “sounding” techniques (e.g., ultrasonic techniques similar to radar), biometric (e.g., temperature), movement of an object that is not specifically configured to interact with the client 102 but may be used to do so (e.g., the keys 226), and so on. A variety of other techniques are also contemplated that may be used to leverage interaction with the surface 120 of the client 102 without departing from the spirit and scope thereof.

As previously described, the user interface module 124 (through the zoom module 126) may leverage inputs provided through the surface 120 to interact with content in a user interface without navigating through different pages or screens. For instance, navigation may be provided through representations of content without being limited to scrolling through hundreds of channels, an example of which may be found in relation to the following figures.

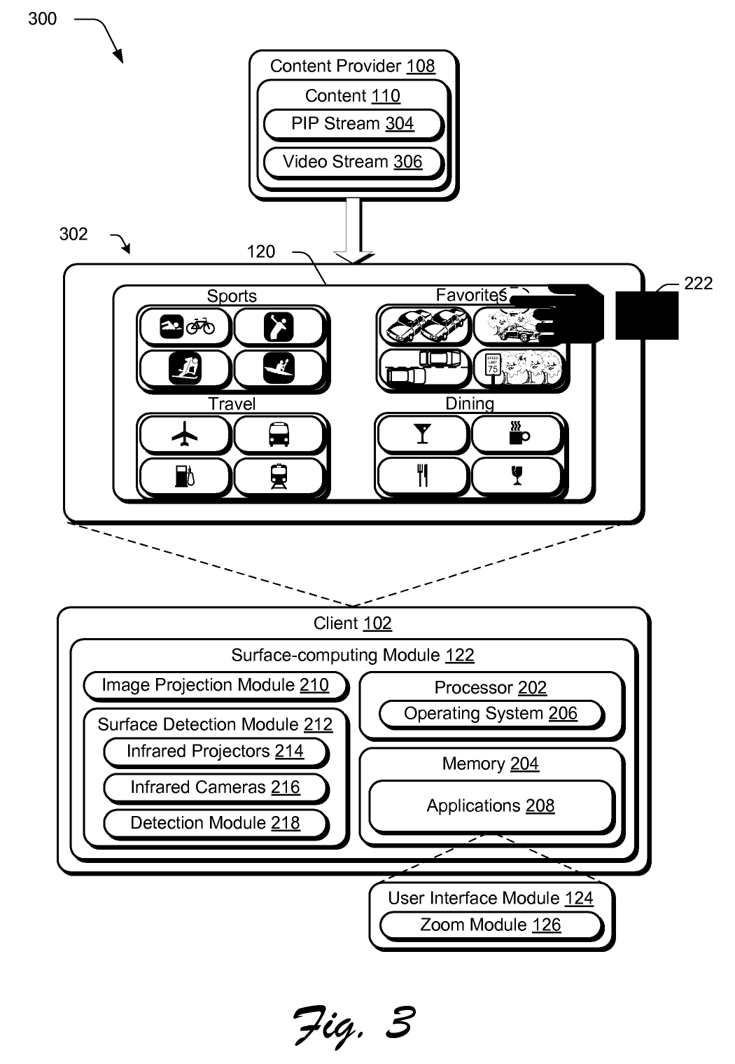

FIG. 3 depicts a system 300 in an example implementation in which the client 102 outputs a user interface 302 that is configured to interact with content 110 received from the content provider 108. In illustrated example, the user interface 302 is output on the surface 120 of the client 102 using the image projection module 210. The user interface 302 includes a plurality of representations of content 110 that are available from the content provider 108 via a respective one of a plurality of channels. The content 110 in the illustrated instance includes a picture-in-picture stream 304 and a video stream 306. The content 110 as previously described may be configured in a variety of different ways, such as television programming, streaming music, and so on.

The representations are illustrated as being grouped according to genre, illustrated examples of which include sports, travel, dining, and favorites. The representations are displayed in a single page in the user interface 302. A user may navigate through the representations in the user interface 302 in a variety of different ways, such as by using one or more fingers of a hand 222 of the user. For example, one or more fingers of the hand 222 of the user may be placed on the surface 120 and moved in a desired direction to pan through the user interface 302, e.g., to move the representations up or down and/or left or right. In this way, a user may access representations that are not currently displayed on the surface 120. Further, these representations may be maintained at a current level of detail in the user interface 302.

As previously described, the user interface 302 may also be configured to support zoom functionality to display different levels of detail for each of the representations of the content 110 available from the content provider 108. For example, the representation currently displayed in the user interface may be still images taken from a picture-in-picture (PIP) stream 304 of content 110 from the content provider 108. In another example, the representations may be icons or other graphical indicators of content that is currently available via respective channels.

A user interacting with the user interface may then select a particular genre of interest, such as by using a finger of the user's hand 222 to select “Favorites”. In response to this selection, the portion of the user interface 302 selected (e.g., Favorites) may be displayed in greater detail, an example of which may be found in relation to the following figure.

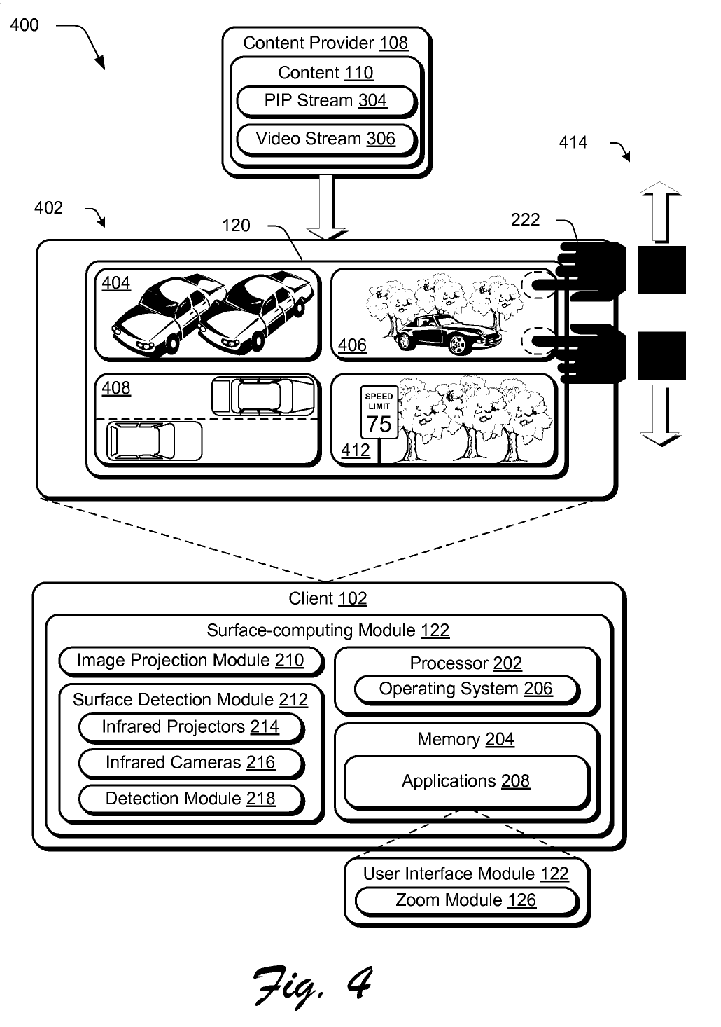

FIG. 4 depicts a system 400 in an example implementation in which the user interface 302 of FIG. 3 is zoomed in such that representations of content in a selected genre are enlarged. The client 102 includes a user interface 402 having representations 404, 406, 408, 410 that are enlarged (i.e., consume a greater amount of display area) when compared with corresponding representations in the user interface 302 of FIG. 3.

The representations 404-410 may also provide additional detail when compared with the representation in the user interface 302 of FIG. 3. For example, the representations 404-410 may be output using a respective picture-in-picture stream 304 of content 110 provided by the content provider 108. In this way, the representations may be displayed “in motion” such that a user may actually see what is currently being output on each of the represented channels. Additionally, additional metadata may also be displayed, such as a name of the content, time on, actors, plot, and so forth.

In this level of detail, the user interface 402 may be panned to move between representations within the genre (e.g., “Favorites”. The user interface 402 may also be panned to move to representations of content in a different genre, e.g., sports, travel, dining, and so on. For example, the user interface 402 of FIG. 4 may be considered a zoomed in view of the user interface 302 of FIG. 3. Accordingly, a user may navigate between genres by dragging a finger of the user's hand 222 in a known direction based on the previous view, e.g., the user interface 302 of FIG. 3.

A user may also select a particular representation to view content corresponding to that representation. As shown in FIG. 4, for example, the user's hands 222 may make a stretching gesture 414 by placing a finger of each hand on the representation 406 displayed on the surface 120 and then moving them apart. Thus, the representation 406 may be enlarged to show the actual content 110 using the video stream 306, an example of which may be found in relation to the following figure.

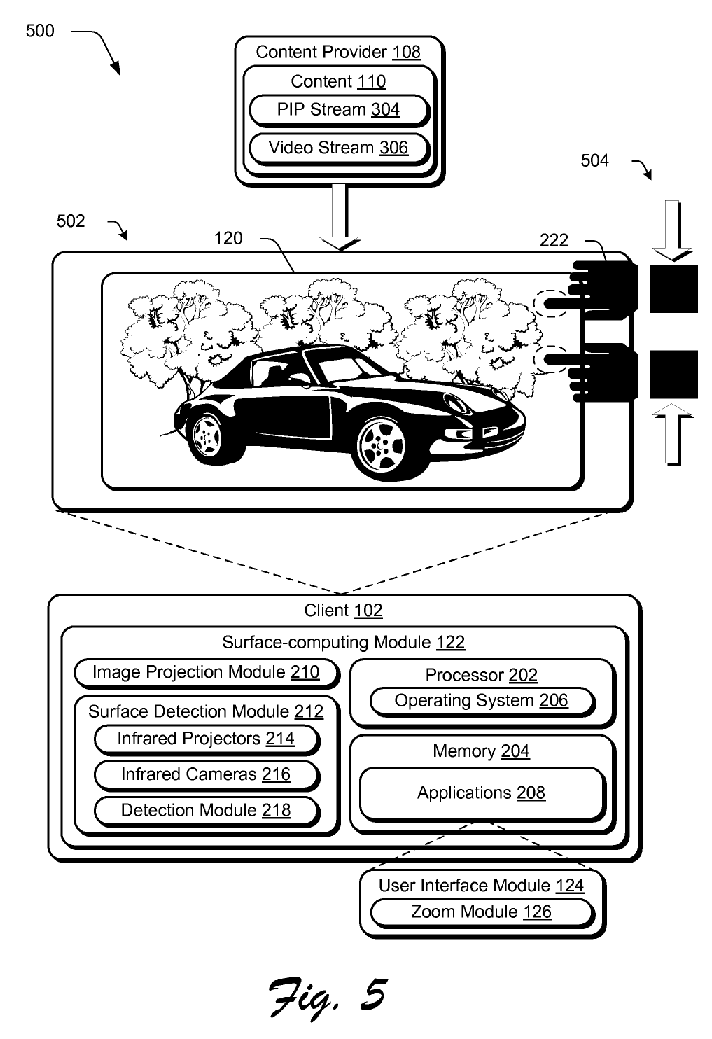

FIG. 5 depicts a system 500 in an example implementation in which a user interface 502 outputs content selected through interaction with the user interface 402 of FIG. 4. The user interface 502 includes content 110 that is output using the video stream 306 of the content provider 108 that provides full display resolution, e.g., standard definition and/or high definition, as opposed to the reduced display resolution available from the picture-in-picture stream 304.

Additionally, the content 110 may be output in the user interface 502 to include audio. For instance, the user interfaces 302, 402 of FIGS. 3 and 4, respectively, may be configured for output without audio. However, the content output using the video stream 306 may be configured to include audio. A variety of other examples are also contemplated, such as to output audio for content that consumes a greater amount of display area of the surface 120 than other content and representations of content.

Although FIGS. 3-5 described zooming in to increase levels of detail of representations of content in user interfaces, the user interfaces may also be zoomed out using similar techniques. For example, fingers of the user's hands 222 may be placed on the surface 120 and moved together to zoom out from the user interface 502 of FIG. 5 back to the user interface 402 of FIG. 4. In this way, a user interface may be provided as a single page in which a user may navigate through levels of detail (e.g., display resolution of content, amount and/or types of metadata displayed, and so on) by zooming in and zooming out and pan through the user interface to display representations that are “off screen” and therefore not currently displayed.

Content provided for output by the client 102 in the user interface using the user interface module 124 may be provided in a variety of ways. For example, the content 110 may be provided by the content provider 108 to create streams having different levels of detail/resolution for different levels of zoom. In an implementation, bandwidth is made constant to communicate these streams regardless of zoom level and number of PIPs shown. In another example, the formatting of the content 110 is performed locally at the client 102, e.g., through execution of the user interface module 124 and zoom module 126 to configure the content 110 once received from the content provider 108 for display in the user interface. A variety of other examples are also contemplated without departing from the spirit and scope thereof, such as through configuration of content that is local to the client 102, e.g., from a personal video recorder (PVR).

Example Procedures

The following discussion describes surface computing and zoom techniques that may be implemented utilizing the previously described systems and devices. Aspects of each of the procedures may be implemented in hardware, firmware, or software, or a combination thereof. The procedures are shown as a set of blocks that specify operations performed by one or more devices and are not necessarily limited to the orders shown for performing the operations by the respective blocks. In portions of the following discussion, reference will be made to the environment 100 of FIG. 1 and the systems 200-500 of FIGS. 2-5.

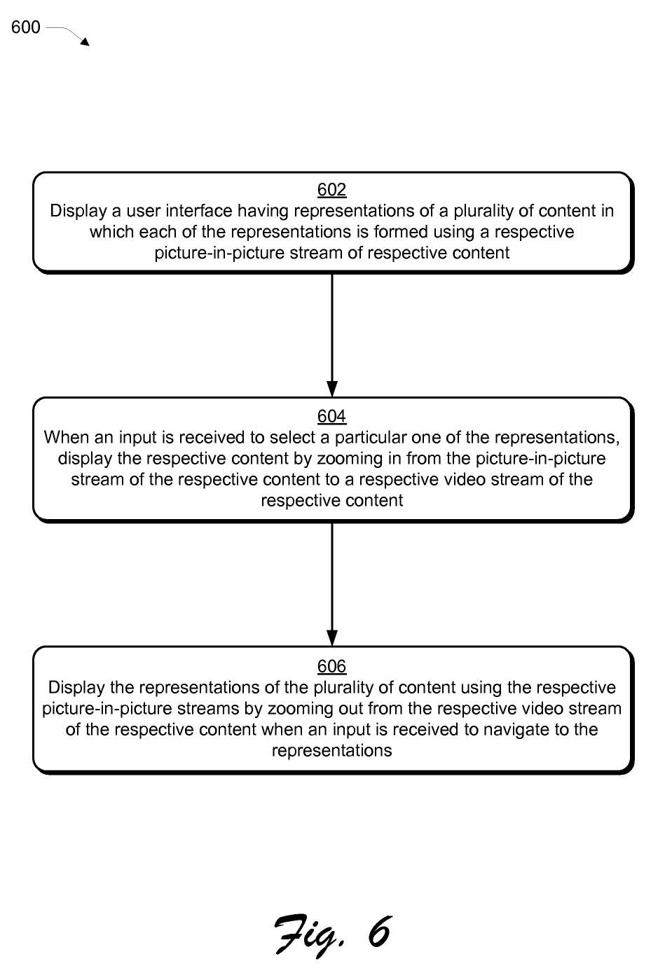

FIG. 6 depicts a procedure 600 in an example implementation in which a user interface having representations of content is navigated through using one or more zoom techniques. A user interface is displayed having representations of a plurality of content in which each of the representations is formed using a respective picture-in-picture stream of respective content (block 602). For example, the user interface 402 of FIG. 4 includes representations of content 110 formed using picture-in-picture streams 304 received from a content provider 108.

When an input is received to select a particular one of the representations, respective content is displayed by zooming in from the picture-in-picture stream of the respective content to respective video stream of the respective content (block 604). The zooming may be performed in a variety of ways, such as by successively enlarging the representations of the picture-in-picture streams in a plurality of intermediate steps until the video stream 306 of the actual content 110 is displayed on the surface 120 of the client 102. In this way, the resolution of the picture-in-picture stream 304 may be increased in the user interface to the resolution of the video stream 306 of the content 110. These techniques may also be reversed to zoom back out through different levels of detail of the user interface.

For example, the representations of the plurality of content are displayed using respective picture-in-picture streams by zooming out from respective video stream of the respective content on an input is received to navigate to the representations (block 606). The input may be provided in a variety of ways, such as by using one or more gestures as previously described in relation to FIGS. 2 through 5.

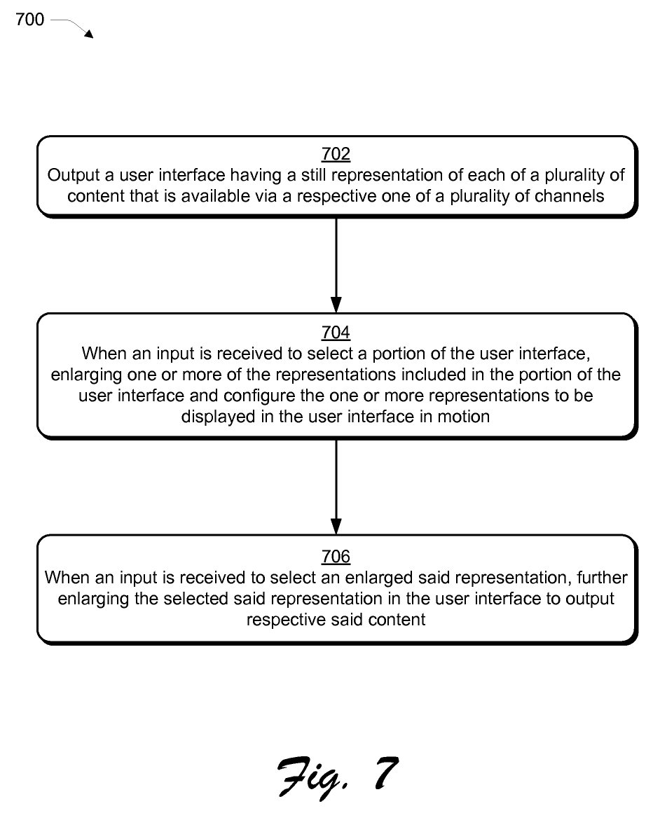

FIG. 7 depicts a procedure 700 in an example implementation in which representations of content in the user interface are enlarged from a still image to a picture-in-picture screen to a video stream. A user interface is output having a still representation of each of a plurality of content that is available via a respective one of a plurality of channels (block 702).

When an input is received to select a portion of the user interface, one or more of the representations included in the portion of the user interface are enlarged and configured to be displayed in the user interface in motion (block 704). The representations, for instance, may be displayed using a picture-in-picture stream 304 of the content 110 from the content provider 108.

When an input is received to select an enlarged one of the representations, the selected representation is further enlarged in the user interface to output respective content (block 706). Continuing with the previous example, the video stream 306 may then be output in the user interface. A variety of other examples are also contemplated without departing from the spirit and scope thereof.

### CONCLUSION

Although the invention has been described in language specific to structural features and/or methodological acts, it is to be understood that the invention defined in the appended claims is not necessarily limited to the specific features or acts described. Rather, the specific features and acts are disclosed as example forms of implementing the claimed invention.

What is claimed is:

1. A method comprising:
displaying a user interface having representations of a plurality of content in which each said representation is formed using a respective picture-in-picture stream of respective said content (602); and
when an input is received to select a particular said representation, displaying the respective said content by zooming in from the picture-in-picture stream of the respective said content to a respective video stream of the respective said content (604).

2. A method as described in claim 1, wherein:
the displaying are performed by a client having a surface;
at least a portion of the surface is used to display the representations of the plurality of content using the respective picture-in-picture stream and to display the respective said content using the respective video stream of the respective said content; and
the input is received via the surface.

3. A method as described in claim 2, wherein the client has a form factor of a table that includes a table top having the surface.

4. A method as described in claim 2, wherein the input is received by recognizing a gesture made by using one or more fingers of a user's hand.

5. A method as described in claim 1, wherein each of the plurality of content is available via a respective one of a plurality of channels.

6. A method as described in claim 1, wherein:
the user interface is an electronic program guide (EPG); and
the plurality of content includes television programming.

7. A method as described in claim 1, further comprising displaying the representations of the plurality of content using the respective picture-in-picture streams by zooming out from the respective video stream of the respective said content when an input is received to navigate to the representations.

8. A method comprising:
outputting a user interface having a still representation of each of a plurality of content that is available via a respective one of a plurality of channels;
when an input is received to select a portion of the user interface, enlarging one or more said representations included in the portion of the user interface and configuring the one or more said representations to be displayed in the user interface in motion; and
when an input is received to select an enlarged said representation, further enlarging the selected said representation in the user interface to output respective said content.

9. A method as described in claim 8, wherein:
the outputting the enlarging, and the further enlarging are performed by a client;
the client has a form factor of a table;
the inputs are received via a surface of the table;
the surface is included as part of a table top of the client; and
the outputting is performed using at least a portion of the surface.

10. A method as described in claim 8, wherein the one or more said representations are displayed in the user interface using respective picture-in-picture streams.

11. A method as described in claim 10, wherein the respective said content is output using a video stream.

12. A method as described in claim 8, wherein the further enlarging is performed such that the respective said content includes audio.

13. A method as described in claim 8, wherein the inputs are received by detecting a stretching gesture made on the surface using one or more fingers of one or more hands of a user.

14. A client (102) comprising:
a housing (116) having a form factor of a table;
a surface (120) disposed on a table top of the housing; and
one or more modules (122) disposed within the housing to:
display a user interface on the surface having representations of a plurality of content; and
when an input is received to select a particular said representation, display respective said content by zooming in from the representations of the plurality of content to the respective said content.

15. A client as described in claim 14, wherein the respective said content is a television program.

16. A client as described in claim 14, wherein the input is received via the surface.

17. A client as described in claim 16, wherein the input is received by detecting a gesture made on the surface using one or more fingers of one or more hands of a user.

18. A client as described in claim 17, wherein the gesture is a stretching gesture.

19. A client as described in claim 14, wherein the respective said content is displayed using a video stream and the representations of the plurality of content is displayed using respective picture-in-picture streams.

20. A client as described in claim 14, wherein the one or more modules include:
a rear-projection system to display the representations and the respective said content on the surface;
one or more infrared projectors to project infrared light on the surface;
one or more infrared cameras to capture infrared images of the surface; and
a detection module to process the infrared images to detect the input.
